(19) United States
(12) Patent Application Publication
(10) Pub. No.: US 2022/0308232 A1
(43) Pub. Date: Sep. 29, 2022

(54) TOF DEPTH MEASURING DEVICE AND METHOD

(71) Applicant: ORBBEC INC., Shenzhen (CN)

(72) Inventors: Fei SUN, SHENZHEN (CN); Wanduo WU, SHENZHEN (CN); Zhaomin WANG, SHENZHEN (CN); Dejin ZHENG, SHENZHEN (CN); Jiaqi WANG, SHENZHEN (CN); Rui SUN, SHENZHEN (CN)

(21) Appl. No.: 17/836,747

(22) Filed: Jun. 9, 2022

Related U.S. Application Data
(63) Continuation of application No. PCT/CN2020/141871, filed on Dec. 30, 2020.

(30) Foreign Application Priority Data
Apr. 20, 2020 (CN) 202010311679.1

(51) Int. Cl. G01S 17/894; G06T 7/521; G01S 7/4865

(52) U.S. Cl. CPC G01S 17/894; G06T 7/521; G01S 7/4865

(57) ABSTRACT

A TOF depth measuring device includes: an emission module projects a dot matrix pattern onto a target object, and an acquisition module includes an image sensor configured to receive reflected optical signals reflected by the target object. First pixels in the pixel array detect reflected optical signals of real light spots reflected by the target object, and second pixels in the pixel array detect reflected optical signals of real light spots reflected more than once. The TOF depth measuring device further includes a processor, connected to the emission module and the acquisition module, filters the first reflected optical signal to obtain a third reflected optical signal, and calculate a phase difference based on the third reflected optical signal to obtain a first depth map of the target object.

### CROSS-REFERENCE TO RELATED APPLICATIONS

This application is a Continuation Application of International Patent Application No. PCT/CN2020/141871, filed on Dec. 30, 2020, which is based on and claims priority to and benefits of Chinese Patent Application No. 202010311679.1, entitled “TOF DEPTH MEASURING DEVICE AND METHOD” filed with the China National Intellectual Property Administration on Apr. 20, 2020. The entire content of all of the above identified applications is incorporated herein by reference.

### TECHNICAL FIELD

This application relates to the field of three-dimensional imaging techniques, and in particular, to a time of flight (TOF) depth measuring device and method.

### BACKGROUND

A depth measuring device of a TOF technique calculates a distance to a target object by calculating a time difference or phase difference of a light beam from being emitted to a target region to being received through reflection by the target object, to obtain depth information of the target object. The depth measuring device based on the TOF technique has begun to be applied to the fields such as three-dimensional measurement, gesture control, robot navigation, security protection, and monitoring.

A conventional TOF depth measuring device usually includes a light source and a camera. The light source emits a flood beam to a target space to supply illumination, and the camera images the reflected flood beam. The depth measuring device calculates a distance of the target by calculating a time required by the beam from being emitted to being received through reflection. However, when the conventional TOF depth measuring device is used for sensing distance, on the one hand, interference from ambient light affects the accuracy of the measurement. For example, when the intensity of the ambient light is relatively high or even reaches submerge the flood light from the light source, it will be difficult to distinguish the light beam of the light source, resulting in a relatively large measurement error. On the other hand, the conventional TOF depth measuring device can measure only a near object, and an extremely large error will be generated during measuring a far object.

To resolve the distance measurement problem, Chinese Patent Application No. 202010116700.2 discloses a TOF depth measuring device. In the TOF depth measuring device, an emission module emits spot beams. Because a spatial distribution of the spot beams is relatively sparse and energy of spots is more concentrated, a measurement distance is longer, and an intensity of direct irradiation is higher than an intensity of multipath reflection. Therefore, an optical signal generated by the multipath can be distinguished, thereby improving a signal-to-noise ratio of a valid signal, to reduce multipath interference. However, in this solution, if the distribution of the spot beams is relatively dense, the multipath interference cannot be eliminated; and if the distribution of the spot beams is relatively sparse, the image resolution is not high.

### SUMMARY

This application provided a TOF depth measuring device and method, to resolve at least one of the problems in the BACKGROUND part.

An embodiment of this application provides a TOF depth measuring device, including: an emission module comprising a light emitter and configured to project a dot matrix pattern onto a target object, wherein the dot matrix pattern comprises real dot matrices formed by real light spots and virtual dot matrices formed by virtual light spots; an acquisition module, configured to receive a first reflected optical signal and a second reflected optical signal, and comprising an image sensor formed by a pixel array, wherein first pixels in the pixel array detect the first reflected optical signal of real light spots reflected by the target object, and second pixels in the pixel array detect the second reflected optical signal of real light spots reflected more than once; and a processor, connected to the emission module and the acquisition module, and configured to: filter the first reflected optical signal according to the second reflected optical signal to obtain a third reflected optical signal, and calculate a phase difference based on the third reflected optical signal to obtain a first depth map of the target object.

In some embodiments, a quantity of the real light spots is greater than a quantity of the virtual light spots.

In some embodiments, the processor is configured to: calculate first depth values of the first pixels in the first depth map, and generate second depth values for the second pixels by interpolation using the first depth values to obtain a second depth map, wherein a resolution of the second depth map is greater than a resolution of the first depth map.

In some embodiments, the real dot matrices and the virtual dot matrices are arranged regularly.

In some embodiments, a dot matrix pattern including a plurality of real light spots surrounding a single virtual light spot has a hexagonal shape or a quadrilateral shape; and the real dot matrices and the virtual dot matrices are arranged alternately.

An embodiment of this application further provides a TOF depth measuring method, including the following steps:

projecting, by an emission module comprising a light emitter, a dot matrix pattern onto a target object, wherein the dot matrix pattern comprises real dot matrices formed by real light spots and virtual dot matrices formed by virtual light spots;

receiving, by an acquisition module comprising an image sensor formed by a pixel array, a first reflected optical signal and a second reflected optical signal, wherein first pixels in the pixel array detect the first reflected optical signal of the real light spots reflected by the target object, and second pixels in the pixel array detect the second reflected optical signal of the real light spots reflected more than once; and

filtering, by a processor, the first reflected optical signal according to the second reflected optical signal to obtain a third reflected optical signal, and calculating a phase difference based on the third reflected optical signal to obtain a first depth map of the target object.

In some embodiments, the processor in configured to calculate first depth values of the first pixels in the first depth map, and generate second depth values for the second pixels by interpolation using the first depth values to obtain a second depth map, wherein a resolution of the second depth map is greater than a resolution of the first depth map.

In some embodiments, the processor is configured to set a detection threshold of the first depth values, search, in vicinity of third pixels having first depth values that are greater than the detection threshold, for fourth pixels having first depth values that are less than the detection threshold, and perform interpolation to obtain depth values for the fourth pixels to obtain the second depth map.

In some embodiments, a quantity of the real light spots is greater than a quantity of the virtual light spots.

In some embodiments, a dot matrix pattern including a plurality of real light spots surrounding a single virtual light spot has a hexagonal shape or a quadrilateral shape; and the real dot matrices and the virtual dot matrices are arranged alternately.

The embodiments of this application provide a non-transitory computer readable storage medium storing a computer program, wherein the computer program, when executed by a processor, causes the processor to perform operations including: controlling an emission module comprising a light emitter to project a dot matrix pattern onto a target object, wherein the dot matrix pattern comprises real dot matrices formed by real light spots and virtual dot matrices formed by virtual light spots; controlling an acquisition module comprising an image sensor formed by a pixel array to receive a first reflected optical signal and a second reflected optical signal, wherein first pixels in the pixel array detect the first reflected optical signal of the real light spots reflected by the target object, and second pixels in the pixel array detect the second reflected optical signal of the real light spots reflected more than once; and filtering the first reflected optical signal according to the second reflected optical signal to obtain a third reflected optical signal, and calculating a phase difference based on the third reflected optical signal to obtain a first depth map of the target object. The TOF depth measuring device of this application resolves a problem of multipath interference of a reflected light beam while achieving a high-resolution depth image.

### BRIEF DESCRIPTION OF THE DRAWINGS

To describe the technical solutions in the embodiments of this application or the existing technologies more clearly, the following briefly describes the accompanying drawings required for describing the embodiments or the existing technologies. Apparently, the accompanying drawings in the following description show only some embodiments of this application, and a person of ordinary skill in the art may derive other drawings from the accompanying drawings without creative efforts.

FIG. 1 is a schematic structural diagram of a TOF depth measuring device, according to an embodiment of this application.

FIG. 2 is a schematic diagram of multipath reflection of an emitted light beam.

FIG. 3a to FIG. 3d are schematic diagrams of a dot matrix pattern projected by an emission module of a TOF depth measuring device, according to an embodiment of this application.

FIG. 4 is a schematic diagram of a pixel array of an image sensor of a TOF depth measuring device, according to an embodiment of this application.

FIG. 5 is a curve diagram of intensities of reflected light generated in the embodiment shown in FIG. 1.

FIG. 6 is a calculation diagram of filtering a stray optical signal in the embodiment shown in FIG. 1.

FIG. 7 is a flowchart of a TOF depth measuring method, according to another embodiment of this application.

FIG. 8 is a diagram of an electronic device to which the TOF depth measuring device in the embodiment shown in FIG. 1 is applied.

### DETAILED DESCRIPTION

To make the technical problems to be resolved, the technical solutions, and the advantageous effects of the embodiments of this application clearer and more comprehensible, the following further describes this application in detail with reference to the accompanying drawings and embodiments. It should be understood that the specific embodiments described herein are merely used to explain this application but to limit this application.

It should be noted that, when an element is described as being “fixed on” or “disposed on” another element, the element may be directly located on the another element, or indirectly located on the another element. When an element is described as being “connected to” another element, the element may be directly connected to the another element, or indirectly connected to the another element. In addition, the connection may be used for fixation or circuit connection.

It should be understood that orientation or position relationships indicated by the terms such as “length,” “width,” “above,” “below,” “front,” “back,” “left,” “right,” “vertical,” “horizontal” “top,” “bottom,” “inside,” and “outside” are based on orientation or position relationships shown in the accompanying drawings, and are used only for ease and brevity of illustration and description of embodiments of this application, rather than indicating or implying that the mentioned apparatus or component needs to have a particular orientation or needs to be constructed and operated in a particular orientation. Therefore, such terms should not be construed as limiting this application.

In addition, terms “first” and “second” are used merely for the purpose of description, and shall not be construed as indicating or implying relative importance or implying a quantity of indicated technical features. In view of this, a feature defined by “first” or “second” may explicitly or implicitly include one or more features. In the description of the embodiments of this application, unless otherwise specifically limited, “a plurality of” means two or more than two.

FIG. 1 is a schematic structural diagram of a TOF depth measuring device, according to an embodiment of this application.

A TOF depth measuring device 10 includes an emission module 11, an acquisition module 12, and a control and processing device 13 separately connected to the emission module 11 and the acquisition module 12. The emission module 11 is configured to project a dot matrix pattern onto a target object 20, where the dot matrix pattern includes real dot matrices formed by real light spots and virtual dot matrices formed by regions without light spot irradiation. The acquisition module 12 includes an image sensor 121 formed by a pixel array, is configured to receive a first reflected optical signal and a second reflected optical signal, where first pixels in the pixel array detect the first reflected optical signal of real light spots reflected by the target object 20, and second pixels in the pixel array detect the second reflected optical signal of real light spots reflected for more than once. The control and processing device 13, such as a processor, is configured to: filter the first reflected optical signal according to the second reflected optical signal to obtain a third reflected optical signal, and calculate a phase difference based on the third reflected optical signal to obtain a first depth map of the target object 20.

The emission module 11 includes a light emitter, such as a light source and a light source drive (not shown in the figure), and the like. The light source may be a light source such as a light-emitting diode (LED), an edge-emitting laser (EEL), or a vertical-cavity surface-emitting laser (VCSEL), or may be a light source array including a plurality of light sources. A light beam emitted by the light source may be visible light, infrared light, ultraviolet light, or the like, and is not particularly limited in the embodiments of this application.

In some embodiments, the emission module 11 further includes a diffractive optical element (DOE), configured to replicate the dot matrix pattern emitted by the light source. It may be understood that dot matrix patterns emitted by the light source are periodically arranged patterns, and adjacent dot matrix patterns are adjacent to each other after being replicated by the DOE. That is, there is no obvious gap or overlap between finally formed patterns.

The acquisition module 12 includes the TOF image sensor 121 and a lens unit, and may further include a light filter (not shown in the figure). The lens unit receives at least a portion of light beams reflected by the target object 20 and images on at least a portion of the TOF image sensor. The light filter is a narrow-band light filter matching a wavelength of the light source, to suppress background light noise of the remaining bands. The TOF image sensor may be an image sensor including a charge-coupled device (CCD), a complementary metal oxide semiconductor (CMOS), an avalanche diode (AD), a single-photon avalanche diode (SPAD), and the like. A size of an array of the sensor represents resolution of a depth camera, for example, 320×240. Generally, a read circuit (not shown in the figure) is further connected to the image sensor 121, and includes one or more of devices such as a signal amplifier, a time-to-digital converter (TDC), and an analog-to-digital converter (ADC).

In some embodiments, the TOF image sensor includes at least one pixel, and each pixel includes two or more taps, used for storing and reading or discharging a charge signal generated by incident photons under the control of a corresponding electrode. For example, each pixel includes two taps, and within a single frame period (or a single exposure time), the taps are switched in a specific sequence to acquire incident photons for receiving an optical signal, and to convert the optical signal into an electrical signal.

The control and processing device 13 may be an independent dedicated circuit, such as a dedicated SOC chip, an FPGA chip, or an ASIC chip that includes a CPU, a memory, a bus, and the like, or may include a general-purpose processing circuit. For example, when the TOF depth measuring device is integrated into a smart terminal such as a mobile phone, a television, or a computer, a processing circuit in the smart terminal may be used as at least a portion of the control and processing device 13.

The control and processing device 13 is configured to provide an emitting instruction signal required by the light source during laser emission, and the light source emits a light beam to the target object 20 under the control of the emitting instruction signal.

In some embodiments, the control and processing device 13 further provides demodulated signals (acquisition signals) of taps of each pixel in the TOF image sensor, and under the control of the demodulated signals, the taps acquire an electrical signal generated by a reflected light beam reflected by the target object 20. It may be understood that the electrical signal is related to an intensity of the reflected light beam, and the control and processing device 13 processes the electrical signal and calculates a phase difference to obtain a distance to the target object 20.

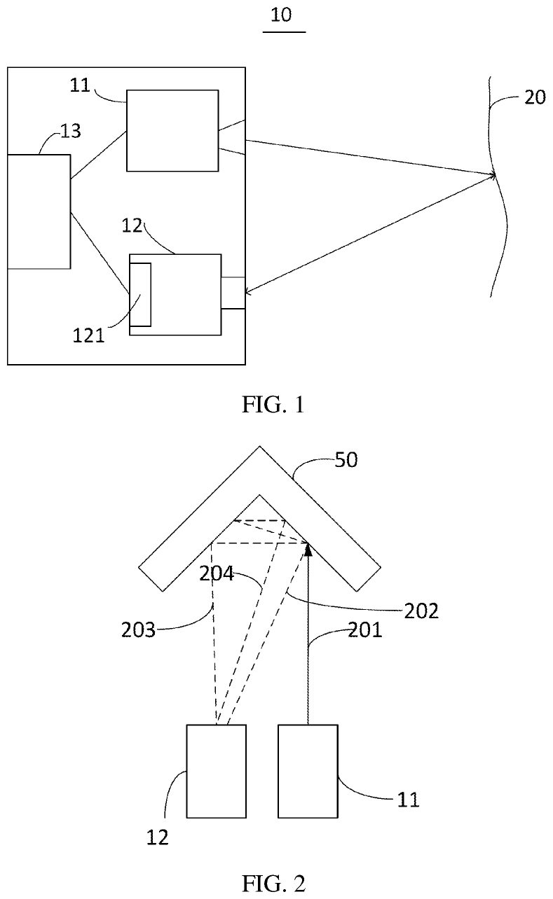

Referring to FIG. 2, a description is made below on a “multipath” situation. Generally, to cover all pixel regions, in the TOF depth measuring device, a flood light is used as the light source. However, flood beams are dense, and a luminous flux received by the pixels is usually not only generated through direct reflection of the target object, but also includes stray light obtained through a plurality of times of reflection. For example, the emission module 11 emits a light beam 201, and the light beam 201 is scattered after irradiating a target object 50, and may be reflected to the acquisition module 12 through a plurality of paths.

In FIG. 2, assuming that the target object 50 is a corner of a wall, the emitted light beam 201 irradiates the target object 50, and the acquisition module 12 detects at least one portion of first reflected light 202 directly reflected from the light beam 201 by the target object 50. If the emitted light beam 201 is scattered to other regions of the target object 50 after irradiating the target object 50, the acquisition module 12 will detect second reflected light 203 having a longer flight path than that of the first reflected light 202. Similarly, the emitted light beam 201 may be scattered more than once, and finally the acquisition module 12 may detect third reflected light 204 having a longer flight path than that of the second reflected light 203. There are even more other paths of reflected light, which results in a “multipath” situation. Because a time-of-flight of directly reflected light is different from that of indirectly reflected light, multipath interference will cause an obtained depth value of a corresponding pixel to be deviated.

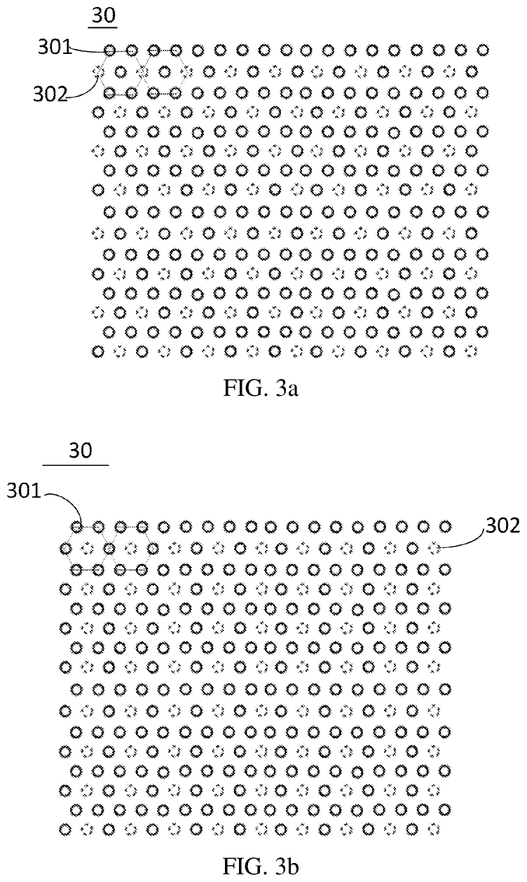

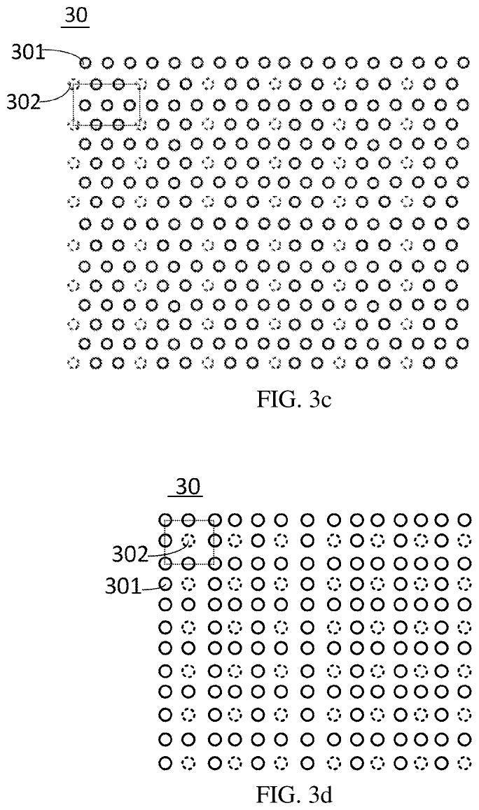

In some embodiments of this application, a dot matrix pattern projected by the emission module is shown in FIG. 3a to FIG. 3d. The dot matrix pattern 30 includes real dot matrices formed by real light spots and virtual dot matrices formed by regions without light spot irradiation. For ease of description, the regions without light spot irradiation are represented by using virtual light spots below. That is, the real light spots form the real dot matrices, and the virtual light spots form the virtual dot matrices. It may be understood that the virtual light spots mentioned in this embodiment are an abstract expression for simpler and clearer description of a real light spot arrangement rule, and should not be simply literally understood as virtual light spots.

As shown in FIG. 3a and FIG. 3b, a dot matrix pattern 30 may be in a hexagonal shape, as shown by dotted lines in the figure, or may be in a quadrilateral shape, as shown in FIG. 3d. In FIG. 3a, a virtual light spot 302 is arranged between every two real light spots 301 in even rows of the dot matrix pattern 30, and a virtual dot matrix pattern formed by a plurality of virtual light spots 302 is arranged crosswise. Similarly, in the dot matrix pattern 30 shown in FIG. 3b, a virtual light spot 302 is arranged between every two real light spots 301 in even rows, and a dot matrix pattern formed by a plurality of virtual light spots 302 is arranged in a plurality of squares. In the dot matrix pattern 30 shown in FIG. 3c, a virtual light spot 302 is arranged between two real light spots 301 and two real light spots 301 in even rows, as shown by dotted lines in the figure, and a dot matrix pattern formed by a plurality of virtual light spots 302 is arranged in a plurality of rectangles. The dot matrix pattern 30 shown in FIG. 3d is in a quadrilateral shape. A virtual light spot 302 is arranged between every two real light spots 301 in even rows, and a dot matrix pattern formed by a plurality of virtual light spots 302 is arranged in a plurality of squares. It may be understood that positions of the virtual light spots and the real light spots shown in the figures are merely for ease of describing diversity of the dot matrix pattern formed by the virtual light spots and the real light spots, and are not limited thereto. The virtual light spots may be in odd rows or in even rows and other positions, and the light spots are not necessarily in circular shape, and may be in other shapes such as an ellipse or a rectangle.

As shown in FIG. 3a to FIG. 3d, the dot matrix pattern formed by a plurality of real light spots 301 surrounding a single one of virtual light spots 302 may be in hexagonal, quadrilateral, or any other shapes. The real dot matrices and the virtual dot matrices are arranged alternately, and a quantity of the real light spots 301 is greater than that of the virtual light spots 302. Therefore, by projecting the dot matrix pattern by the emission module 11, the multipath effect can be reduced, and the image resolution can be improved. It may be understood that the real dot matrices and the virtual dot matrices may be arranged regularly or irregularly. Preferably, a regular arrangement is adopted, which makes a distribution of the depth values more regular.

A description is made below by using an example in which the emission module projects the dot matrix pattern shown in FIG. 3d onto the target object. The image sensor 121 detects a first reflected optical signal of the real light spots 301 reflected by the target object 20 and detects a second reflected optical signal that is not directly reflected by the target object 20. The control and processing device filters the first reflected optical signal based on the second reflected optical signal. It may be understood that the second reflected optical signal includes a stray optical signal, and the first reflected optical signal includes an optical signal of the real light spots directly reflected from the target object and a stray optical signal. The stray optical signal in the first reflected optical signal is filtered based on the second reflected optical signal, to obtain the optical signal of the real light spots (namely, the foregoing third reflected optical signal) directly reflected from the target object to improve a signal-to-noise ratio of an image.

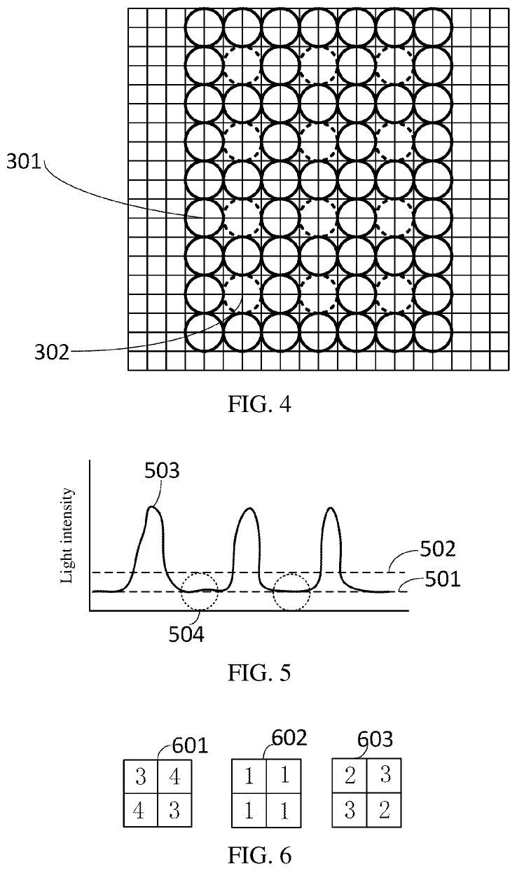

As shown in FIG. 3d, the emission module 11 projects a dot matrix pattern 30 onto the target object 20, where the dot matrix pattern 30 includes a plurality of real light spots 301 (which are represented by using solid circles) and a plurality of virtual light spots 302 (which are represented by using dashed circles). As shown in FIG. 4, a portion of pixels in the pixel array of the image sensor 121 acquire the first reflected optical signal of the plurality of real light spots 301 reflected by the target object 20, and another portion of the pixels in the pixel array of the image sensor 121 acquire the second reflected optical signal that is not directly reflected by the target object 20. For ease of description, it is assumed that each real light spot 301 and each virtual light spot 302 approximately occupy 2×2=4 pixels. Actually, the real light spot 301 and the virtual light spot 302 may have other sizes. It may be understood that if the real light spots are relatively densely distributed, fewer pixels are occupied by the virtual light spots. In this case, calculated resolution of a depth map is higher. It should be noted that the pixels occupied by the virtual light spots refers to a dot matrix pattern with respect to the real light spots that are relatively densely distributed, but not a comparison between pixels occupied by virtual light spots and pixels occupied by real light spots. That is, it is an overall comparison, but not a comparison between a single virtual light spot and a single real light spot.

For example, photons received by pixels corresponding to the real light spots 301 include the optical signal of real light spots 301 directly reflected from the target object (i.e., the real light spots 301 reflected once by the target object) and a stray optical signal generated by multipath (i.e., the real light spots 301 reflected by the target object or other objects for more than once) or background light. Photons received by pixels corresponding to the virtual light spots 302 include only the stray optical signal. Because the energy of the optical signal of the real light spots directly reflected from the target object is greater than that of stray light, an optical signal intensity of the pixels occupied by the real light spots 301 is significantly higher than an optical signal intensity of the pixels occupied by the virtual light spots 302. The control and processing device 13 may filter out, based on a stray optical signal intensity of the pixels occupied by the virtual light spots 302, the stray optical signal received by the pixels occupied by the real light spots 301.

As shown in FIG. 5, for example, a detection threshold may be set for searching for the pixels occupied by the virtual light spots 302. The acquisition module 12 detects a peak intensity 503 in each real light spot 301 and a stray optical signal intensity 501 of the pixels occupied by the virtual light spots 302. The control and processing device 13 may search, by setting a detection threshold 502, for the pixels occupied by the virtual light spots. For example, the detection threshold 502 may be set to be a constant greater than the stray optical signal intensity 501 of the pixels occupied by the virtual light spots 302. In some embodiments, the detection threshold 502 is set to be greater than but close to the stray optical signal intensity 501. Thus, a difference between 502 and 501 is less than a difference between 503 and 502.

It may be understood that the peak intensity 503 (namely, the foregoing first reflected optical signal) is a sum of an intensity of the optical signal of the real light spots directly reflected from the target object and the stray optical signal intensity 501, and the stray optical signal intensity 501 is the foregoing second reflected optical signal. Therefore, the stray optical signal included in the peak intensity 503 is filtered based on the stray optical signal intensity 501, to obtain the optical signal of the real light spots directly reflected from the target object. As shown in FIG. 6, assuming that the first optical signal of the real light spots reflected from the target object occupies pixels 601 and the stray optical signal occupies pixels 602, the pixels 601 occupied by the first optical signal are filtered according to an average value of the pixels of the stray optical signal, to obtain pixel values 603 of the optical signal of the real light spots directly reflected from the target object. In this way, the signal-to-noise ratio of the image can be improved.

In some embodiments, the control and processing device 13 may calculate a phase difference based on the optical signal of the real light spots directly reflected from the target object to obtain a first depth map, calculate depth values on pixels corresponding to the real light spots in the first depth map, and perform interpolation for pixels corresponding to the virtual light spots using the depth values of the real light spots to obtain a second depth map having a higher resolution. It may be understood that the control and processing device 13 may set a detection threshold (e.g. 502) of the depth values according to the method shown in FIG. 5, where a pixel having a depth value that is greater than the detection threshold (e.g., 502) is a valid pixel (e.g., pixel(s) having intensity 503), that is, a valid pixel corresponding to a real light spot; and then search for pixels (e.g., pixels having intensity 501) having depth values that are less than the detection threshold (e.g., 502) surrounding the valid pixel, to perform interpolation for the pixels having depth values that are less than the detection threshold using the depth values of the real light spots in the vicinity of the pixels having depth values that are less than the detection threshold.

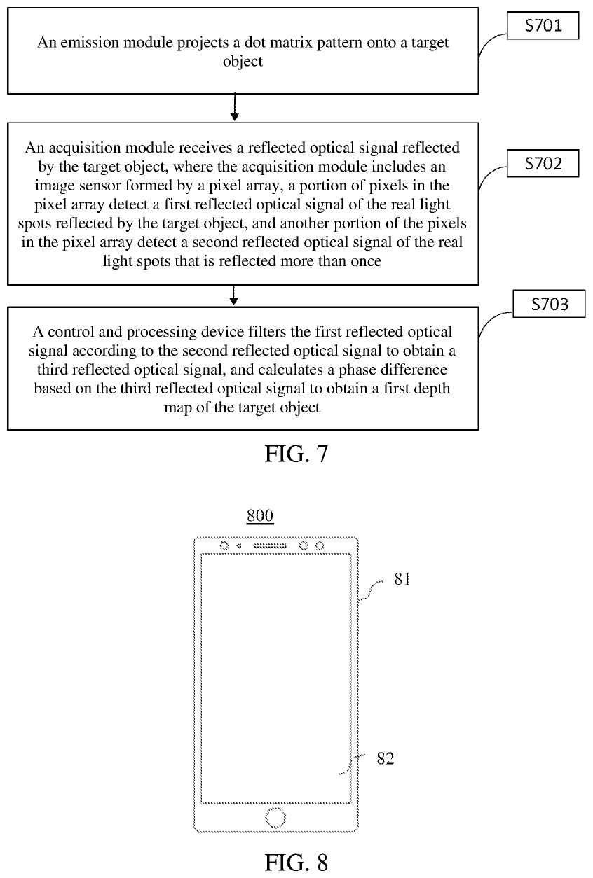

Referring to FIG. 7, another embodiment of this application further provides a TOF depth measuring method. FIG. 7 is a flowchart of the TOF depth measuring method according to this embodiment. The method includes the following steps.

S701: An emission module projects a dot matrix pattern onto a target object, where the dot matrix pattern includes real dot matrices formed by real light spots and virtual dot matrices formed by regions without light spot irradiation.

For example, the emission module projects a dot matrix pattern onto the target object, where in the dot matrix pattern, a quantity of the real dot matrices is greater than that of the virtual dot matrices. The real dot matrices and the virtual dot matrices are arranged regularly and crosswise. A dot matrix pattern formed by a plurality of real light spots surrounding a single light spot in a virtual dot matrix may be in a quadrilateral or a hexagonal shape.

S702: An acquisition module receives a reflected optical signal reflected by the target object, where the acquisition module includes an image sensor formed by a pixel array. A portion of pixels in the pixel array detect a first reflected optical signal of the real light spots reflected by the target object, and another portion of the pixels in the pixel array detect a second reflected optical signal of the real light spots that is reflected more than once.

In some embodiments, a portion of pixels in the pixel array detect at least a portion of reflected optical signals of the real light spots directly reflected (i.e., reflected once) by the target object, and another portion of the pixels in the pixel array detect light beams including reflected background light or scattered real light spots.

S703: A control and processing device filters the first reflected optical signal according to the second reflected optical signal to obtain a third reflected optical signal, and calculates a phase difference based on the third reflected optical signal to obtain a first depth map of the target object.

For example, the control and processing device may calculate a phase difference based on an optical signal of the real light spots directly reflected from the target object to obtain a first depth map, calculate depth values on pixels corresponding to the real light spots in the first depth map, and perform interpolation to obtain depth values for pixels corresponding to the virtual light spots based on the depth values of the real light spots to obtain a second depth map having a higher resolution than that of the first depth map. It may be understood that the control and processing device 13 may set a threshold of the depth values, where a pixel having a depth value that is greater than the threshold is a valid pixel, that is, a valid pixel corresponding to a real light spot, and then search for pixels having depth values that are less than the threshold surrounding the valid pixel, to perform interpolation to obtain depth values for the pixels having depth values that are less than the threshold.

In another embodiment of this application, an electronic device is further provided. The electronic device may be a desktop device, a desktop installed device, a portable device, a wearable device, an in-vehicle device, a robot, or the like. For example, the device may be a notebook computer or an electronic device, to allow gesture recognition or biometric recognition. In another example, the device may be a head-mounted device to identify objects or hazards in a surrounding environment of a user to ensure safety. For example, a virtual reality system that blocks vision of the user to the environment can detect objects or hazards in the surrounding environment, to provide the user with a warning about a nearby object or obstacle. In some other examples, the electronic device may be a mixed reality system that mixes virtual information and images with the surrounding environment of the user, and can detect objects or people in the environment around the user to integrate the virtual information with the physical environment and the objects. In another example, the electronic device may be a device applied to fields such as autonomous driving. Referring to FIG. 8, a description is made by using a mobile phone as an example. An electronic device 800 includes a housing 81, a screen 82, and the TOF depth measuring device described in the foregoing embodiments. The emission module 11 and the acquisition module 12 of the TOF depth measuring device are arranged on the same surface of the electronic device 800, and are configured to: emit a flood beam to a target object, receive a flood beam reflected by the target object, and form an electrical signal.

An embodiment of this application further provides a non-transitory computer readable storage medium, configured to store a computer program, where the computer program, when being executed, at least performs the foregoing method.

The storage medium may be implemented by any type of volatile or non-volatile storage device, or a combination thereof. The non-volatile memory may be a read-only memory (ROM), a programmable ROM (PROM), an erasable PROM (EPROM), an electrically EPROM (EEPROM), a ferromagnetic random access memory (FRAM), a flash memory, a magnetic surface memory, a compact disc, or a compact disc ROM (CD-ROM); and the magnetic surface memory may be a magnetic disk storage or a magnetic tape storage. The volatile memory may be a random access memory (RAM), used as an external cache. Through exemplary but non-limitative descriptions, RAMs in lots of forms may be used, for example, a static RAM (SRAM), a synchronous SRAM (SSRAM), a dynamic RAM (DRAM), a synchronous DRAM (SDRAM), a double data rate SDRAM (DDR SDRAM), an enhanced SDRAM (ESDRAM), a SyncLink DRAM (SLDRAM), and a direct Rambus RAM (DRRAM). The storage medium according to this embodiment of this application includes, but not limited to, these and any other suitable types of memories.

It may be understood that the foregoing contents are detailed descriptions of this application in conjunction with specific/exemplary embodiments, and it should not be considered that the specific implementation of this application is merely limited to these descriptions. A person of ordinary skill in the art, to which this application belong, may make various replacements or variations on the described implementations without departing from the concept of this application, and the replacements or variations should fall within the protection scope of this application. In the descriptions of this specification, descriptions using reference terms “an embodiment,” “some embodiments,” “an exemplary embodiment,” “an example,” “a specific example,” or “some examples” mean that specific characteristics, structures, materials, or features described with reference to the embodiment or example are included in at least one embodiment or example of this application.

In this specification, schematic descriptions of the foregoing terms are not necessarily directed at the same embodiment or example. Besides, the specific features, the structures, the materials or the characteristics that are described may be combined in proper manners in any one or more embodiments or examples. In addition, a person skilled in the art may integrate or combine different embodiments or examples described in the specification and features of the different embodiments or examples provided that they are not contradictory to each other. Although the embodiments of this application and advantages thereof have been described in detail, it should be understood that various changes, substitutions, and alterations can be made herein without departing from the scope defined by the appended claims.

In addition, the scope of this application is not limited to the specific embodiments of the processes, machines, manufacturing, material composition, means, methods, and steps described in the specification. A person of ordinary skill in the art can easily understand and use the above disclosures, processes, machines, manufacturing, material composition, means, methods, and steps that currently exist or will be developed later and that perform substantially the same functions as the corresponding embodiments described herein or obtain substantially the same results as the embodiments described herein. Therefore, the appended claims include such processes, machines, manufacturing, material compositions, means, methods, or steps within the scope thereof.

What is claimed is:

1. A device for measuring time of flight (TOF) depth, comprising:
an emission module comprising a light emitter and configured to project a dot matrix pattern onto a target object, wherein the dot matrix pattern comprises real dot matrices formed by real light spots and virtual dot matrices formed by virtual light spots;
an acquisition module comprising an image sensor formed by a pixel array and configured to receive a first reflected optical signal and a second reflected optical signal, wherein first pixels in the pixel array detect the first reflected optical signal of real light spots reflected by the target object, and second pixels in the pixel array detect the second reflected optical signal of real light spots reflected more than once; and
a processor, connected to the emission module and the acquisition module, and configured to: filter the first reflected optical signal according to the second reflected optical signal to obtain a third reflected optical signal, and calculate a phase difference based on the third reflected optical signal to obtain a first depth map of the target object.

2. The device according to claim 1, wherein a quantity of the real light spots is greater than a quantity of the virtual light spots.

3. The device according to claim 1, wherein the processor is configured to: calculate first depth values of the first pixels in the first depth map, and generate second depth values for the second pixels by interpolation using the first depth values to obtain a second depth map, wherein a resolution of the second depth map is greater than a resolution of the first depth map.

4. The device according to claim 1, wherein the real dot matrices and the virtual dot matrices are arranged regularly.

5. The device according to claim 1, wherein a dot matrix pattern including a plurality of real light spots surrounding a single virtual light spot has a hexagonal shape or a quadrilateral shape; and the real dot matrices and the virtual dot matrices are arranged alternately.

6. A time of flight (TOF) depth measuring method, comprising:
projecting, by an emission module comprising a light emitter, a dot matrix pattern onto a target object, wherein the dot matrix pattern comprises real dot matrices formed by real light spots and virtual dot matrices formed by virtual light spots;
receiving, by an acquisition module comprising an image sensor formed by a pixel array, a first reflected optical signal and a second reflected optical signal, wherein first pixels in the pixel array detect the first reflected optical signal of the real light spots reflected by the target object, and second pixels in the pixel array detect the second reflected optical signal of the real light spots reflected more than once; and
filtering, by a processor, the first reflected optical signal according to the second reflected optical signal to obtain a third reflected optical signal, and calculating a phase difference based on the third reflected optical signal to obtain a first depth map of the target object.

7. The method according to claim 6, wherein the processor is configured to calculate first depth values of the first pixels in the first depth map, and generate second depth values for the second pixels by interpolation using the first depth values to obtain a second depth map, wherein a resolution of the second depth map is greater than a resolution of the first depth map.

8. The method according to claim 7, wherein the processor is configured to set a detection threshold of the first depth values, search, in vicinity of pixels having first depth values that are greater than the detection threshold, for pixels having first depth values that are less than the detection threshold, and performs interpolation for the pixels having the first depth values that are less than the detection threshold to obtain the second depth map.

9. The method according to claim 6, wherein a quantity of the real light spots is greater than a quantity of the virtual light spots.

10. The method according to claim 6, wherein a dot matrix pattern including a plurality of real light spots surrounding a single virtual light spot has a hexagonal shape or a quadrilateral shape; and the real dot matrices and the virtual dot matrices are arranged alternately.

11. A non-transitory computer readable storage medium storing a computer program, wherein the computer program, when executed by a processor, causes the processor to perform operations comprising:
controlling an emission module comprising a light emitter to project a dot matrix pattern onto a target object, wherein the dot matrix pattern comprises real dot matrices formed by real light spots and virtual dot matrices formed by virtual light spots;
controlling an acquisition module comprising an image sensor formed by a pixel array to receive a first reflected optical signal and a second reflected optical signal, wherein first pixels in the pixel array detect the first reflected optical signal of the real light spots reflected by the target object, and second pixels in the pixel array detect the second reflected optical signal of the real light spots reflected more than once; and
filtering the first reflected optical signal according to the second reflected optical signal to obtain a third reflected optical signal, and calculating a phase difference based on the third reflected optical signal to obtain a first depth map of the target object.

12. The medium according to claim 11, wherein the operations further comprise:
calculating first depth values of the first pixels in the first depth map, and generating second depth values for the second pixels by interpolation using the first depth values to obtain a second depth map, wherein a resolution of the second depth map is greater than a resolution of the first depth map.

13. The medium according to claim 12, wherein the operations further comprise:
setting a detection threshold of the first depth values;
searching, in vicinity of third pixels having first depth values that are greater than the detection threshold, for fourth pixels having first depth values that are less than the detection threshold; and
performing interpolation to obtain depth values for the fourth pixels to obtain the second depth map.

14. The medium according to claim 11, wherein a quantity of the real light spots is greater than a quantity of the virtual light spots.

15. The medium according to claim 11, wherein a dot matrix pattern including a plurality of real light spots surrounding a single virtual light spot has a hexagonal shape or a quadrilateral shape; and the real dot matrices and the virtual dot matrices are arranged alternately.
